(19) United States
(12) Patent Application Publication
(10) Pub. No.: US 2026/0093477 A1
(43) Pub. Date: Apr. 2, 2026

(54) Program Transfer and Initialization for Multi-Core Dataflow Acceleration

(71) Applicant: International Business Machines Corporation, Armonk, NY (US)

(72) Inventors: Shubham Jain, Elmsford, NY (US); Alberto Mannari, Basel (CH); Swagath Venkataramani, White Plains, NY (US); Vijayalakshmi Srinivasan, New York, NY (US)

(21) Appl. No.: 18/899,064

(22) Filed: Sep. 27, 2024

(51) Int. Cl. G06F 8/658

(52) U.S. Cl. CPC G06F 8/658

(57) ABSTRACT

According to an illustrative embodiment, a computer-implemented method for program initialization and transfer in a multi-core dataflow accelerator is provided. A base program comprising a number of instructions is generated and multicast to a number of computing cores in the multi-core dataflow accelerator, wherein the based program is stored in local memory units of the computing cores. A number of patches are then applied to a subset of the computing cores, wherein the patches change one or more instructions in the base program that differ from program requirements in the subset of the computing cores, and wherein the patches are multicast to computing cores within the subset that require a same patch.

### BACKGROUND

The disclosure relates generally to program initialization, and more specifically to program transfer from main memory to instruction buffers in AI accelerators.

Artificial intelligence (AI) accelerators are massively parallel dataflow architectures with thousands of execution engines organized into compute arrays and cores. AI accelerators enjoy peak compute capabilities exceeding 100 Tera-Operations per second (TOPs), leading to each deep learning operation taking only hundred or thousands of cycles to finish.

To keep hardware design simple, energy efficient, and low cost, software (a compiler) explicitly manages dataflow and tensor residency, providing sufficient flexibility to execute AI workloads end-to-end using a significant number of (simple) programmable units throughout the accelerator system. This leads to a large program footprint for each operation. These programs are resident in the DDR (Double Data Rate) memory of the device and are transferred to the accelerator cores just-in-time.

### SUMMARY

According to an illustrative embodiment, a computer-implemented method for program initialization and transfer in a multi-core dataflow accelerator is provided. A base program comprising a number of instructions is generated and multicast to a number of computing cores in the multi-core dataflow accelerator, wherein the based program is stored in local memory units of the computing cores. A number of patches are then applied to a subset of the computing cores, wherein the patches change one or more instructions in the base program that differ from program requirements in the subset of the computing cores, and wherein the patches are multicast to computing cores within the subset that require a same patch. According to other illustrative embodiments, a computer system and computer program product for program initialization and transfer in a multi-core dataflow accelerator are provided.

### BRIEF DESCRIPTION OF THE DRAWINGS

FIG. 1 shows the building block of the baseline systolic dataflow architecture in which the illustrative embodiments may be employed;

FIG. 2 shows a diagram illustrating a summary overview of program uniformization across computing cores with smart patching in accordance with an illustrative embodiment;

FIG. 3 depicts an example creation of a base program without compression in accordance with an illustrative embodiment;

FIG. 4 depicts the identification of opportunities for compression using patch flits in accordance with an illustrative embodiment;

FIG. 5 illustrates program uniformization in accordance with an illustrative embodiment;

FIG. 6A illustrates the construction of code blocks shared across cores in accordance with an illustrative embodiment;

FIG. 6B illustrates the application of patches to the code blocks in accordance with an illustrative embodiment;

FIG. 7A illustrates immediate-to-register operand optimization for uniformization in accordance with an illustrative embodiment;

FIG. 7B illustrates immediate-to-register operand optimization for uniformization in accordance with an illustrative embodiment;

FIG. 8 illustrates a high level hardware system for program initialization in accordance with an illustrative embodiment; and

FIG. 9 depicts a flowchart illustrating a process of program initialization and transfer in a multi-core dataflow accelerator in accordance with an illustrative embodiment.

### DETAILED DESCRIPTION

A computer-implemented method for program initialization and transfer in a multi-core dataflow accelerator. A base program comprising a number of instructions is generated and multicast to a number of computing cores in the multi-core dataflow accelerator, wherein the based program is stored in local memory units of the computing cores. A number of patches are then applied to a subset of the computing cores, wherein the patches change one or more instructions in the base program that differ from program requirements in the subset of the computing cores, and wherein the patches are multicast to computing cores within the subset that require a same patch. As a result, the illustrative embodiment provides a technical effect of reducing the total number of data transfers to initialize programs in muti-core dataflow processors compared to transferring separate programs to the cores.

As part of generating the base program, a number of respective programs for the computing cores are divided into code blocks for all the computing cores. The base program is created considering unique code blocks across all the computing cores. Program uniformization is applied to maximize similarity of the respective programs across the computing cores, wherein the base program includes additional instructions to equalize program length across all the computing cores and ensure that analogous instructions across the computing cores appear in a same position and reference a same set of register indices. The computing cores are grouped based on patching requirements. A compiler artifact is generated that includes binaries for all the computing cores with the uniformized base program, zero or more patches, and program initialization and transfer control sequence details. The compiler artifact is then loaded into a program distribution unit for multicast to the computing cores. As a result, the illustrative embodiment provides a technical effect of making the base program similar across computing cores, thereby reducing the number of necessary patches and total data transfers.

In the illustrative embodiment, the additional instructions comprise at least one of dead code or redundant register initializations. As a result, the illustrative embodiment provides a technical effect of equalizing the length of programs across the computing cores.

In the illustrative embodiment, the patches replace the dead code or redundant register initializations with new dead code or new redundant register initializations or with new instructions. As a result, the illustrative embodiment provides a technical effect of customizing the base program according to needs of specific computing cores.

In the illustrative embodiment, the patches add instructions that are missing from the base program or redundant register initialization instructions that correct program behavior. As a result, the illustrative embodiment provides a technical effect of customizing the base program according to needs of specific computing cores.

In the illustrative embodiment, the patches replace immediate values in the instructions with a register read. As a result, the illustrative embodiment provides a technical effect of reducing the total number of required patch flits.

As part of generating the base program, respective programs for the computing cores are divided into code blocks, wherein some of the code blocks are common to subsets of the computing cores, wherein the base program comprises all of the code blocks. For any code block not used by one of the computing cores, the patches convert the first instruction in that code block to a Jump instruction. For code blocks that contain only one instruction, the patches convert the one instruction to a No Operation instruction or the Jump instruction. As a result, the illustrative embodiment provides a technical effect of co-operative compilation of programs across multiple computing cores.

A computer system comprises one or more computer processors, one or more computer readable storage devices, and computer program instructions, the computer program instructions being stored on the one or more computer readable storage devices for execution by the one or more computer processors to perform the following operations. A base program comprising a number of instructions is generated. The processors multicast the base program to a number of computing cores in the multi-core dataflow accelerator, wherein the based program is stored in local memory units of the computing cores. The processors then apply a number of patches to a subset of the computing cores, wherein the patches change one or more instructions in the base program that differ from program requirements in the subset of the computing cores, and wherein the patches are multicast to computing cores within the subset that require a same patch. As a result, the illustrative embodiment provides a technical effect of reducing the total number of data transfers to initialize programs in muti-core dataflow processors compared to transferring separate programs to the cores.

As part of generating the base program, the processors divide a number of respective programs for the computing cores into code blocks for all the computing cores. The base program is created considering unique code blocks across all the computing cores. Program uniformization is applied to maximize similarity of the respective programs across the computing cores, wherein the base program includes additional instructions to equalize program length across all the computing cores and ensure that analogous instructions across the computing cores appear in a same position and reference a same set of register indices. The computing cores are grouped based on patching requirements. A compiler artifact is generated that includes binaries for all the computing cores with the uniformized base program, zero or more patches, and program initialization and transfer control sequence details. The compiler artifact is then loaded into a program distribution unit for multicast to the computing cores. As a result, the illustrative embodiment provides a technical effect of making the base program similar across computing cores, thereby reducing the number of necessary patches and total data transfers.

In the illustrative embodiment, the additional instructions comprise at least one of dead code or redundant register initializations. As a result, the illustrative embodiment provides a technical effect of equalizing the length of programs across the computing cores.

In the illustrative embodiment, the patches replace the dead code or redundant register initializations with new dead code or new redundant register initializations or with new instructions. As a result, the illustrative embodiment provides a technical effect of customizing the base program according to needs of specific computing cores.

In the illustrative embodiment, the patches add instructions that are missing from the base program or redundant register initialization instructions that correct program behavior. As a result, the illustrative embodiment provides a technical effect of customizing the base program according to needs of specific computing cores.

In the illustrative embodiment, the patches replace immediate values in the instructions with a register read. As a result, the illustrative embodiment provides a technical effect of reducing the total number of required patch flits.

As part of generating the base program, the processors divide respective programs for the computing cores into code blocks, wherein some of the code blocks are common to subsets of the computing cores, wherein the base program comprises all of the code blocks. For any code block not used by one of the computing cores, the patches convert the first instruction in that code block to a Jump instruction. For code blocks that contain only one instruction, the patches convert the one instruction to a No Operation instruction or the Jump instruction. As a result, the illustrative embodiment provides a technical effect of co-operative compilation of programs across multiple computing cores.

In the illustrative embodiments, a computer program product for program initialization and transfer in a multi-core dataflow accelerator is provided. The computer program product comprises a persistent storage medium having program instructions configured to cause one or more processors to perform the following operations. A base program comprising a number of instructions is generated and multicast to a number of computing cores in the multi-core dataflow accelerator, wherein the based program is stored in local memory units of the computing cores. A number of patches are applied to a subset of the computing cores, wherein the patches change one or more instructions in the base program that differ from program requirements in the subset of the computing cores, and wherein the patches are multicast to computing cores within the subset that require a same patch. As a result, the illustrative embodiment provides a technical effect of reducing the total number of data transfers to initialize programs in muti-core dataflow processors compared to transferring separate programs to the cores.

As part of generating the base program, the program instructions cause the one or more processors to divide a number of respective programs for the computing cores into code blocks for all the computing cores. The base program is created considering unique code blocks across all the computing cores. Program uniformization is applied to maximize similarity of the respective programs across the computing cores, wherein the base program includes additional instructions to equalize program length across all the computing cores and ensure that analogous instructions across the computing cores appear in a same position and reference a same set of register indices. The computing cores are grouped based on patching requirements. A compiler artifact is generated that includes binaries for all the computing cores with the uniformized base program, zero or more patches, and program initialization and transfer control sequence details. The compiler artifact is then loaded into a program distribution unit for multicast to the computing cores. As a result, the illustrative embodiment provides a technical effect of making the base program similar across computing cores, thereby reducing the number of necessary patches and total data transfers.

In the illustrative embodiment, the additional instructions comprise at least one of dead code or redundant register initializations. As a result, the illustrative embodiment provides a technical effect of equalizing the length of programs across the computing cores.

In the illustrative embodiment, the patches replace the dead code or redundant register initializations with new dead code or new redundant register initializations or with new instructions. As a result, the illustrative embodiment provides a technical effect of customizing the base program according to needs of specific computing cores.

In the illustrative embodiment, the patches replace immediate values in the instructions with a register read. As a result, the illustrative embodiment provides a technical effect of reducing the total number of required patch flits.

As part of generating the base program, the program instructions cause the one or more processors to divide respective programs for the computing cores into code blocks, wherein some of the code blocks are common to subsets of the computing cores, wherein the base program comprises all of the code blocks. For any code block not used by one of the computing cores, the patches convert the first instruction in that code block to a Jump instruction. For code blocks that contain only one instruction, the patches convert the one instruction to a No Operation instruction or the Jump instruction. As a result, the illustrative embodiment provides a technical effect of co-operative compilation of programs across multiple computing cores.

The illustrative embodiments recognize and take into account that the cost of program transfer in dataflow accelerators can be commensurate with (and sometimes even exceed) the execution time due to a large program footprint and impressive peak compute capabilities of the system. Program transfer costs directly impact application throughput (inferences/second). This disparity in execution time versus program initialization time will grow as the performance of accelerators scale.

As compute per operation increases, the execution time grows, but program sizes remain relatively constant. More work can be accomplished by increasing loop count without affecting program footprint. Compute per operation growth can come from larger AI models or larger minibatch size.

The illustrative embodiments also recognize and take into account that, generating individual programs for each computing core and then finding common code blocks is an NP (nondeterministic polynomial time)-Hard problem. Therefore, a high-level intermediate representation that captures each core’s work is used to identify common blocks.

Dataflow accelerators have the capability to multi-cast program data to its different cores and then use correction flits to customize the program for each core. The illustrative embodiments provide a compiler methodology to exploit this multi-cast capability to improve program transfer costs. During code generation, when an operation is parallelized across processors cores, programs are cooperatively generated such that common operations appear at the same position in the program for each core, which can be multicast to the cores. Multicast is a method that allows a single source to send data to multiple recipients in parallel. Examples of such common dataflow components include data transfer between different levels of the memory/scratchpad, operations executed by the different compute arrays. Corrections and updates specific to each core can then be supplied individually through a unicast or multicast when a subset of cores require the same correction. This process reduces the overall program footprint and program transfer cost.

The illustrative embodiments synergistically combine register assignment (multiple instructions from different cores using the same register) with intermediate-to-register transformation to reduce the number of correction flit.

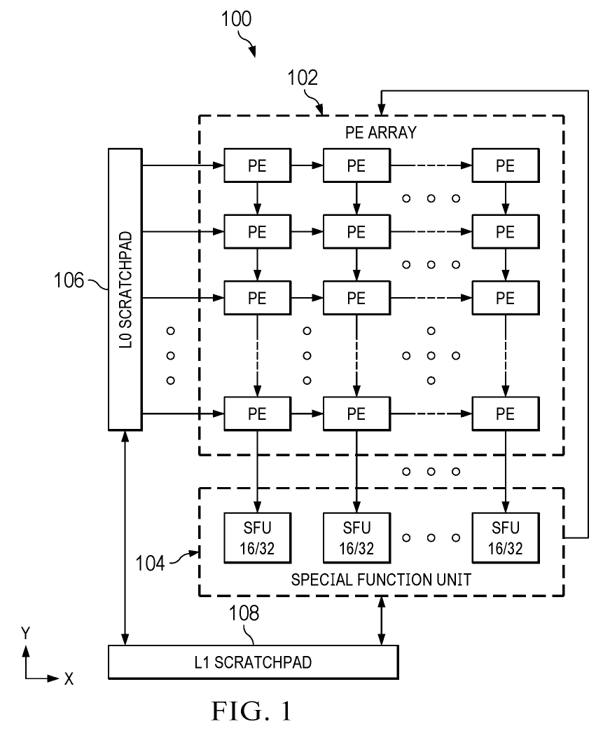

FIG. 1 shows the building block of the baseline systolic dataflow architecture 100 in which the illustrative embodiments may be employed. The main computation unit comprises an 8x8 2D-systolic array 102 of Processing Elements (PEs) supporting 16-bit floating-point (FP16) computations to execute convolution and matrix multiplication operations in DNNs (deep neural networks), and a 1D-array 104 of Special Function Units (SFUs) supporting both 16 and 32-bit floating-point computations (FP16 and FP32) to perform activation functions, pooling, gradient reduction and normalization operations, which may require higher bit precisions.

Each PE contains an 8-way SIMD multiply-and-accumulate (MAC) unit whose operands are received from the PE’s North/West neighbors or from its Local Register File (LRF). Similarly, the output of the MAC is sent to either the South neighbor PE or written back to the LRF. Since the typical dataflows used did not require diagonal flow of operands, the PEs of a given row execute the same instruction sequence in a systolic fashion. Each SFU also contains 8-way SIMD MACs in higher-precision which operate as a vector unit.

A 2-tiered memory hierarchy of scratchpads feeds data to the PE array and SFUs. The L0 scratchpad memory 106 is used to feed data along the rows (X direction). The L1 scratchpad memory 108 is connected to the L0 memories and columns (Y direction) of the SFU/PE array on one side and interfaces with the external memory on the other.

To provide maximum flexibility, the baseline architecture is fully decentralized by decoupling compute and dataflow through the different components into multiple separate threads of execution. Similar to the access-execute paradigm, programmable units are located at the end points of each (or set of) link(s) in the architecture to have fine-grained control over the sequence of data through the link(s). For example, to orchestrate dataflow between L1 and L0, a programmable unit located near the L1 controls the address sequence read from the L1 and pushes the data on the link. Upon receiving the data, a programmable unit near L0 determines the location where it needs to be stored in L0. The SFUs also run their individual programs. They can read/write data operands from/to any of their incoming/outgoing links and their local register file.

Execution of a DNN operation is therefore orchestrated through multiple programs which can be broadly classified into: (i) Data sequencing programs that load/store data from the scratchpad memories and feed them in sequence to PE/SFUs, and (ii) Data processing programs that define the set of computations executed on PE/SFUs on the incoming data elements. To ensure correct functionality (e.g., producer-consumer dependency), the architecture 100 uses token-based hardware support for synchronization between selected programmable units. For example, consider when data is moved from L1 to L0 and then subsequently streamed to the PE array, the program writing data into L0 and the one reading it synchronize periodically to ensure writes precede reads.

The illustrative embodiments employ hardware-software techniques to optimize program initialization and transfer costs in a multi-core dataflow accelerator system. Program uniformization compilation generates programs such that the overall program footprint is reduced by sharing programs across cores with patch support. As part of this uniformization, dead code and redundant register initializations may be purposefully introduced to make dissimilar (or missing) program regions (or blocks) across cores more similar. Patches can subsequently replace the dead code or redundant register initializations with new dead code or redundant register initializations or with new instructions (explained in more detail below). Dead code is a section of code in a program that is executed but not used, accessed, or referenced during operation. Redundant register initialization occurs when a processor register is initialized (assigned a value) more than once before it is used.

Programs are separated into 1) regular programs that are multicast (and shared) across all cores, and 2) one or more small sets of patch flits (flow control units) that are multicast to multiple cores to make specific corrections in various cores.

Hardware support enables program deliver and initialization with smart patching of uniform programs. This support provides the ability to multicast regular programs and patch flits as well as the ability to selectively correct one or more program regions using patch flits.

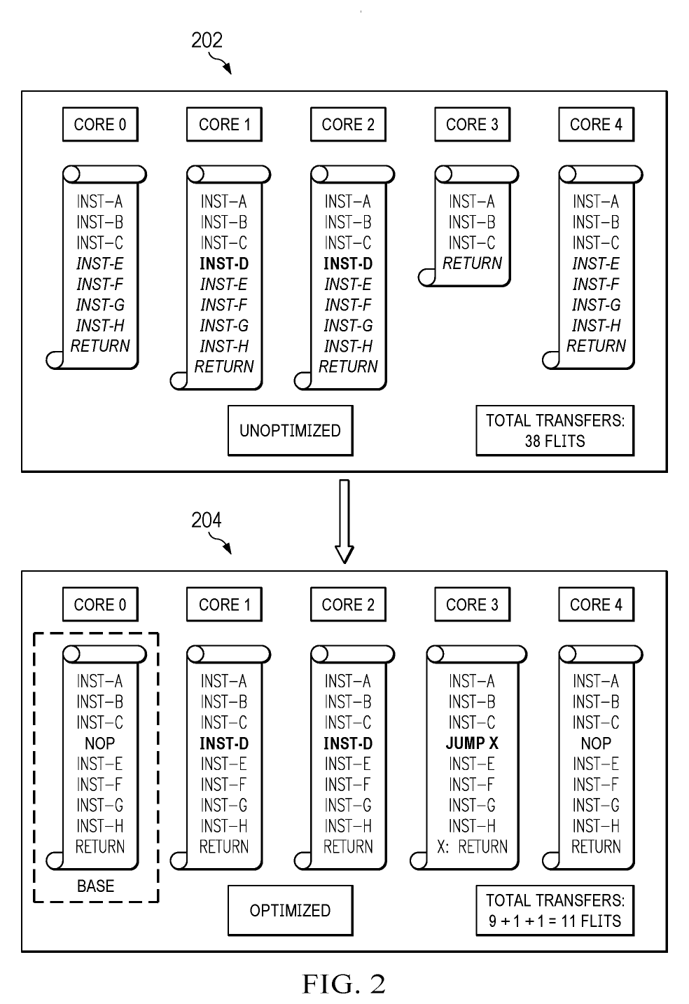

FIG. 2 shows a diagram illustrating a summary overview of program uniformization across computing cores with smart patching in accordance with an illustrative embodiment. The example shown in FIG. 2 involves five computing cores (core 0 – core 4). Each core has a separate program.

Starting with the unoptimized situation 202, each core has a separate program. In this unoptimized approach, program initialization would a total transfer of 38 flits (4 flits for core 3, 8 flits each for cores 0 and 4, and 9 flits each for cores 1 and 2). However, by using the instructions (i.e. computer code that controls how a computer performs microoperations in a series) that occur in the various programs for the different cores, a single, uniform base program is constructed and then multicast to all the cores. This base program is designed to be as similar as possible to the programs across the different cores. Therefore, the base program is optimized for the cores as a group, rather than individually. As a result, after the multicast of the base program, each core will have some instructions it does not need and will lack some instructions it requires. After multicasting the base program to the cores, the process then selectively patches smaller regions in one or more of the cores. The patches may add instructions that are missing from the base program or redundant register initialization instructions that correct program behavior.

In the present example, the programs of all the cores have instructions A through C and Return in common. The program for core 3 includes instructions A though C and Return. The programs for cores 1 and 2 also include instructions D through H, while the programs for cores 0 and 4 do not include instruction D but do include instructions E though H as well.

Therefore, for the optimized situation 204, the optimized base program that is multicast to all five cores includes instructions A-C, No Operation (NOP) Instruction (in place of instruction D), E-H, and Return (9 flits). Missing instruction D (1 flit) is then multicast as a patch to cores 1 and 2, and a Jump instruction (1 flit) is unicast to core 3 to skip instructions E-H and go directly to Return. Since the programs for cores 0 and 4 do not include instruction D, no operation is performed at that step.

In the present example, the net result is to reduce the total number of transfers from 38 flits in the unoptimized situation 202 to 11 flits in the optimized situation 204. Though using the uniform, base program followed by patches is not optimal for a single given core, it does optimize program initialization across all the cores as a group.

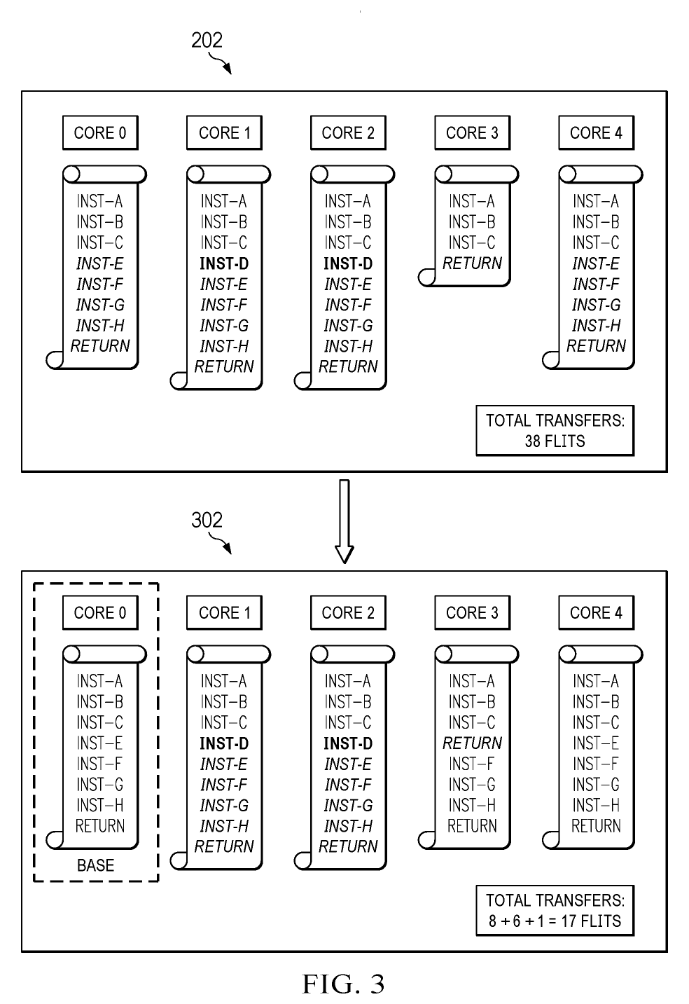

FIG. 3 depicts an example creation of a base program without compression in accordance with an illustrative embodiment. This example starts with the same unoptimized situation 202 shown in FIG. 2.

In this example, instead of applying compression to create the base program, the program of core 0 (8 flits) is simply used, unaltered, as the base program and multicast to all the cores. Using the unaltered core 0 program as the base program results in misalignment of program instructions in the sequence of positions in other cores, resulting in a mismatch across the cores. For example, in cores 1 and 2, not only does instruction D need to be added to the sequence, all the other instructions in the sequence after instruction C have to be moved down one position. Therefore, the multicast patch to cores 1 and 2 must include 6 flits instead of 1. In the case of core 3, instruction E is simply replaced with Return, and the rest of the instructions in the sequence can be ignored.

Therefore, the total transfers for situation 302 is 17 flits, which is a dramatic improvement over situation 202. However, as explained below, the process of generating the base program can be improved to arrive at the optimized situation 204 in FIG. 2.

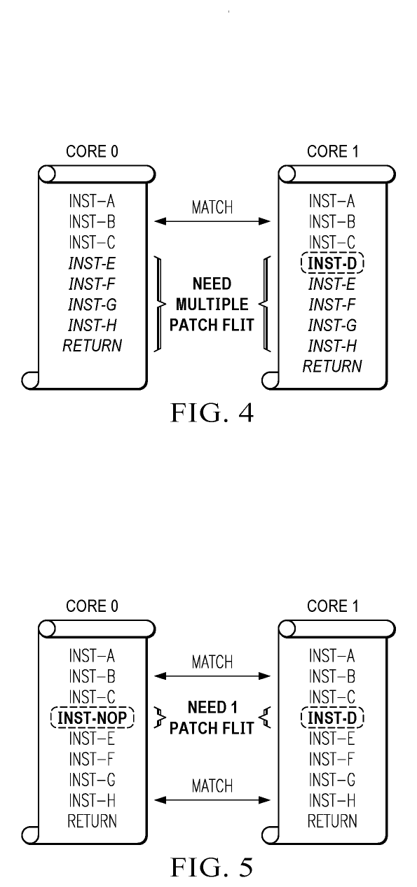

FIG. 4 depicts the identification of opportunities for compression using patch flits in accordance with an illustrative embodiment. The effectiveness of patching relies on programs being similar across cores.

At a high level, although all cores are participating in executing the same layer, differences in their programs can stem from small differences in functionality (e.g., few cores designated to do zero-padding in convolution) such as program instruction count and register indices used in the programs. There might also be differences in tensor regions accessed by the cores such as memory/scratchpad addresses and offsets and core-to-core communication patterns.

In the examples shown in FIG. 4, the program for core 1 has one additional instruction in the middle (INST-D) compared to the program for core 0. This additional instruction requires all subsequent instructions to be patched as well, necessitating multiple patch flits. Because a patch flit is applied to the LX (load extended) address where the program is stored, a small change in program structure can result in a large number of patch flits.

The compiler can overcome this issue by generating a “uniformized” program wherein instructions in most LX-addresses match.

FIG. 5 illustrates program uniformization in accordance with an illustrative embodiment. When multiple cores cooperatively execute the same layer, uniformization generates programs such that analogous instructions across the cores appear in the same position in the program and use the same set of register indices (the content of the registers might vary). Furthermore, program lengths are equalized.

Continuing with the examples of the programs for core 0 and core 1, adding a NOP instruction at the fourth position in the program for core 0 results in the positions of INST-E through Return to match across both core 0 and core 1. Therefore, the program for core 0 can be multicast to the other cores, and only 1 patch flit is needed to handle the mismatch between INST-D and NOP.

Ironically, though uniformization provides compression, it often lengthens individual programs from their original form. However, such lengthening helps increase the uniformity of those programs across cores, thereby minimizing the number of differences between them and consequently reducing the number of necessary patches. Therefore, the uniformized base program plus patches result in less total data transfers, thereby providing compression across all cores compared to transferring separate programs to the cores.

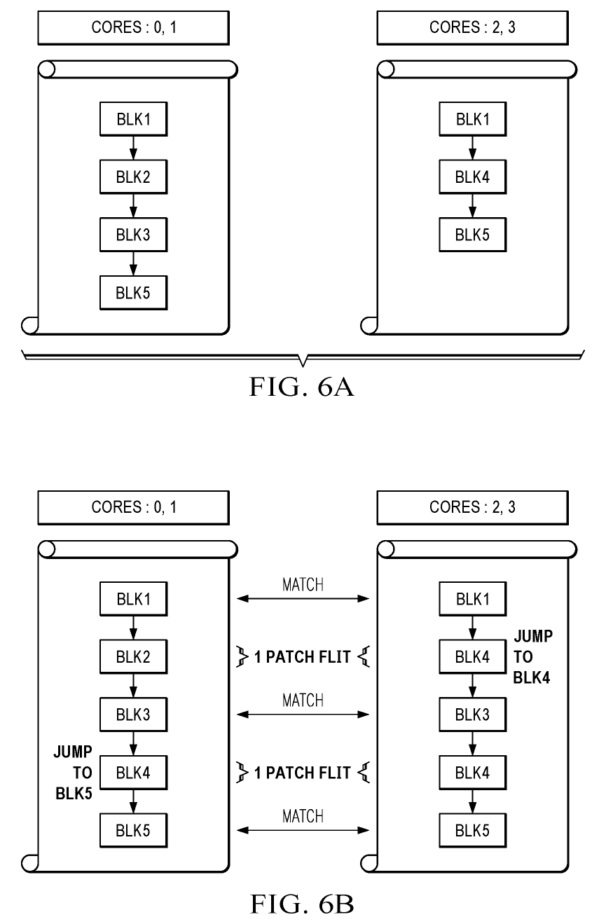

FIGS. 6A and 6B illustrate a compiler technique for uniformization of programs in accordance with an illustrative embodiment. FIG. 6A illustrates the construction of code blocks shared across cores. FIG. 6B illustrates the application of patches to the code blocks.

The program of a core can be divided into multiple code blocks. Some of the code blocks are shared across subsets of cores, while other code blocks might be unique to each core. In the present example in FIG. 6A, cores 0 and 1 share code blocks 1, 2, 3, and 5. Cores 2 and 3 share code blocks 1, 4, and 5. Therefore, cores 0 and 1 comprise one “unionized” list of code blocks, and cores 2 and 3 comprise another unionized list of code blocks.

Code is independently generated for each code block in a core-agnostic fashion, which ensures that the same set of register indices is used and the instruction count is the same across cores. As shown in FIG. 6B, a base program including every code block in the program is multicast to each core to create uniformity across the cores. Each code block comprises multiple instructions. If a core does not use a particular code block, a patch flit is used to convert the first instruction in the code block to a Jump, while leaving the remaining instructions in the code block the same. For code blocks that contain only one instruction, the patches convert the one instruction to a No Operation (NOP) instruction or the Jump instruction.

In the present example, cores 0 and 1 do not use code block 4. Therefore, a patch flit inserts a Jump to code block 5 at the beginning of the instructions in code block 4. Similarly, cores 2 and 3 do not use code blocks 2 and 3. Therefore, a patch flit inserts a Jump to code block 4 at the beginning of code block 2, thereby bypassing both code blocks 2 and 3.

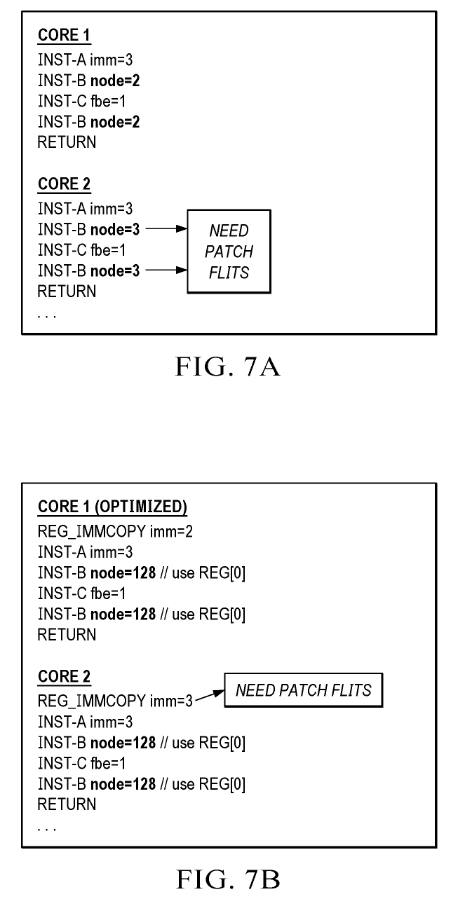

FIGS. 7A and 7B illustrate immediate-to-register operand optimization for uniformization in accordance with an illustrative embodiment. This process converts constant immediate (imm) values in instructions to register reads (i.e. REG[0]) to reduce the total number of required patch flits. Register pressure is purposefully increased to enable better program uniformization.

In the present example, the “node” field differs for LDU instructions across the cores. As shown in FIG. 7A, Core 1 uses immediate value 2 (node=2), and core 2 uses immediate value 3 (node=3), resulting in a mismatch between the cores. Instead of patching multiple INST-B instructions, the node value can come from a register (node=128), as shown in FIG. 7B. In this manner, the register only needs to be patched once.

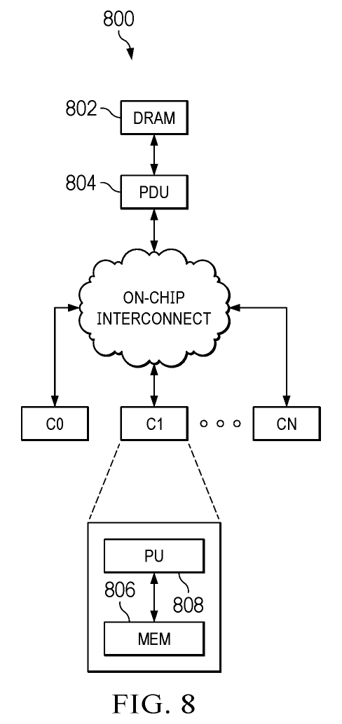

FIG. 8 illustrates a high level hardware system for program initialization in accordance with an illustrative embodiment. The hardware system 800 provides the ability to multicast programs (regular and flits) to multiple cores C0-CN from a program distribution unit (PDU) 804. The hardware system 800 also provides the ability to selectively patch portions of program stored in a memory unit 806 inside of a core by using a patching unit (PU) 808. The PDU 804 has the ability to store programs and to load from DRAM 802 and store in a local buffer while the cores are executing a previous program.

The software method provides the uniformization compilation technique to identify and compile a base (regular) program shared across cores and the ability to perform initialization compression uniformization with patching (co-compiling programs of multiple cores and utilizing dead code from the based program). The software method also provides the ability to generate patches that can be shared across multiple cores.

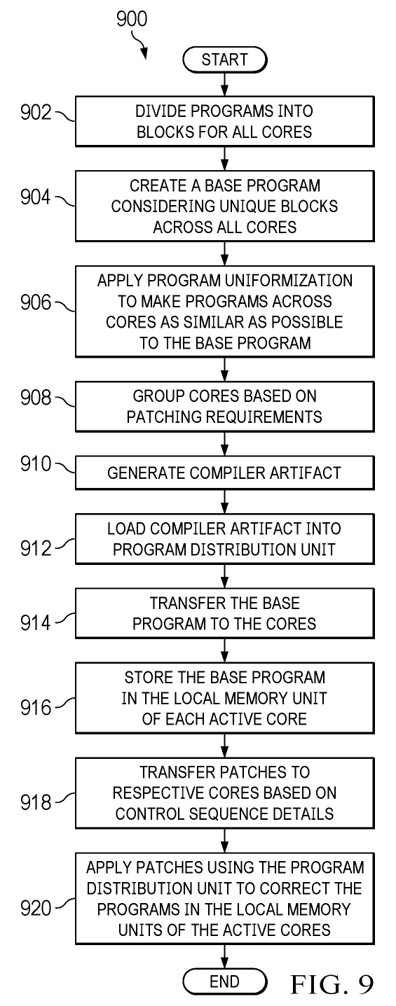

FIG. 9 depicts a flowchart illustrating a process of program initialization and transfer in a multi-core dataflow accelerator in accordance with an illustrative embodiment. Process 900 can be implemented in hardware system 800 in FIG. 8. Process 900 is divided into a compilation phase comprising steps 902-910 and a runtime phase comprising steps 912-920.

Process 900 begins by dividing programs into code blocks for all cores (step 902) and creating a base program considering unique code blocks across all cores (step 904). Program uniformization technique is applied to make the programs across cores as similar as possible to the base program (step 906), and the cores are grouped based on patching requirements (step 908).

A compiler artifact is then generated (step 910). The compiler artifact comprises binaries for all cores with the uniformized program, zero or more patches (patches might not be needed), and program initialization and transfer control sequence details for PDUs and PUs.

The compiler artifact is loaded into the PDU (step 912), and the base program is transferred to the cores (step 914).

The base program is stored in the local memory unit of each active core (step 916). Patches are then transferred to respective cores based on the control sequence details (step 918).

The patches are applied using the PU to correct the programs in the local memory units of the active cores (step 920). Process 900 then ends.

As used herein, “a number of” when used with reference to items, means one or more items. For example, “a number of parameters” is one or more parameters. As another example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method for program initialization and transfer in a multi-core dataflow accelerator, the method comprising:
generating a base program comprising a number of instructions;
multicasting the base program to a number of computing cores in the multi-core dataflow accelerator, wherein the based program is stored in local memory units of the computing cores; and
applying a number of patches to a subset of the computing cores, wherein the patches change one or more instructions in the base program that differ from program requirements in the subset of the computing cores, and wherein the patches are multicast to computing cores within the subset that require a same patch.

2. The method of claim 1, wherein generating the base program further comprises:
dividing a number of respective programs for the computing cores into code blocks for all the computing cores;
creating the base program considering unique code blocks across all the computing cores;
applying program uniformization to maximize similarity of the respective programs across the computing cores, wherein the base program includes additional instructions to equalize program length across all the computing cores and ensure that analogous instructions across the computing cores appear in a same position and reference a same set of register indices;
grouping the computing cores based on patching requirements;
generating a compiler artifact that includes binaries for all the computing cores with the uniformized base program, zero or more patches, and program initialization and transfer control sequence details; and
loading the compiler artifact into a program distribution unit for multicast to the computing cores.

3. The method of claim 2, wherein the additional instructions comprise at least one of:
dead code; or
redundant register initializations.

4. The method of claim 3, wherein the patches replace the dead code or redundant register initializations with:
new dead code or new redundant register initializations; or
new instructions.

5. The method of claim 1, wherein the patches add:
instructions that are missing from the base program; or
redundant register initialization instructions that correct program behavior.

6. The method of claim 1, wherein the patches replace immediate values in the instructions with a register read.

7. The method of claim 1, wherein generating the base program further comprises dividing respective programs for the computing cores into code blocks, wherein some of the code blocks are common to subsets of the computing cores, wherein the base program comprises all of the code blocks, and wherein, for any code block not used by one of the computing cores, the patches convert a first instruction in that code block to a Jump instruction, wherein for code blocks that contain only one instruction, the patches convert the one instruction to a No Operation instruction or the Jump instruction.

8. A computer system for program initialization and transfer in a multi-core dataflow accelerator, comprising:
one or more computer processors;
one or more computer readable storage devices; and
computer program instructions, the computer program instructions being stored on the one or more computer readable storage devices for execution by the one or more computer processors to perform one or more operations to:
generate a base program comprising a number of instructions;
multicast the base program to a number of computing cores in the multi-core dataflow accelerator, wherein the based program is stored in local memory units of the computing cores; and
apply a number of patches to a subset of the computing cores, wherein the patches change one or more instructions in the base program that differ from program requirements in the subset of the computing cores, and wherein the patches are multicast to computing cores within the subset that require a same patch.

9. The system of claim 8, wherein the program instructions that cause the system to generate the base program further cause the system to:
divide a number of respective programs for the computing cores into code blocks for all the computing cores;
create the base program considering unique code blocks across all the computing cores;
apply program uniformization to maximize similarity of the respective programs across the computing cores, wherein the base program includes additional instructions to equalize program length across all the computing cores and ensure that analogous instructions across the computing cores appear in a same position and reference a same set of register indices;
group the computing cores based on patching requirements;
generate a compiler artifact that includes binaries for all the computing cores with the uniformized base program, zero or more patches, and program initialization and transfer control sequence details; and
load the compiler artifact into a program distribution unit for multicast to the computing cores.

10. The system of claim 9, wherein the additional instructions comprise at least one of:
dead code; or
redundant register initializations.

11. The system of claim 10, wherein the patches replace the dead code or redundant register initializations with:
new dead code or new redundant register initializations; or
new instructions.

12. The system of claim 8, wherein the patches add:
instructions that are missing from the base program; or
redundant register initialization instructions that correct program behavior.

13. The system of claim 8, wherein the patches replace immediate values in the instructions with a register read.

14. The system of claim 8, wherein the program instructions that cause the system to generate the base program further cause the system to divide respective programs for the computing cores into code blocks, wherein some of the code blocks are common to subsets of the computing cores, wherein the base program comprises all of the code blocks, and wherein, for any code block not used by one of the computing cores, the patches convert a first instruction in that code block to a Jump instruction, wherein for code blocks that contain only one instruction, the patches convert the one instruction to a No Operation instruction or the Jump instruction.

15. A computer program product for program initialization and transfer in a multi-core dataflow accelerator, the computer program product comprising:
a persistent storage medium having program instructions configured to cause one or more processors to:
generate a base program comprising a number of instructions;
multicast the base program to a number of computing cores in the multi-core dataflow accelerator, wherein the based program is stored in local memory units of the computing cores; and
apply a number of patches to a subset of the computing cores, wherein the patches change one or more instructions in the base program that differ from program requirements in the subset of the computing cores, and wherein the patches are multicast to computing cores within the subset that require a same patch.

16. The computer program product of claim 15, wherein the program instructions for generating the base program further comprise instructions to cause the processors to:
divide a number of respective programs for the computing cores into code blocks for all the computing cores;
create the base program considering unique code blocks across all the computing cores;
apply program uniformization to maximize similarity of the respective programs across the computing cores, wherein the base program includes additional instructions to equalize program length across all the computing cores and ensure that analogous instructions across the computing cores appear in a same position and reference a same set of register indices;
group the computing cores based on patching requirements;
generate a compiler artifact that includes binaries for all the computing cores with the uniformized base program, zero or more patches, and program initialization and transfer control sequence details; and
load the compiler artifact into a program distribution unit for multicast to the computing cores.

17. The computer program product of claim 16, wherein the additional instructions comprise at least one of:
dead code; or
redundant register initializations.

18. The computer program product of claim 17, wherein the patches replace the dead code or redundant register initializations with:
new dead code or new redundant register initializations; or
new instructions.

19. The computer program product of claim 15, wherein the patches replace immediate values in the instructions with a register read.

20. The computer program product of claim 15, wherein the program instructions for generating the base program further comprise instructions to cause the processors to divide respective programs for the computing cores into code blocks, wherein some of the code blocks are common to subsets of the computing cores, wherein the base program comprises all of the code blocks, and wherein, for any code block not used by one of the computing cores, the patches convert a first instruction in that code block to a Jump instruction, wherein for code blocks that contain only one instruction, the patches convert the one instruction to a No Operation instruction or the Jump instruction.
